(19) United States
(12) Patent Application Publication
(10) Pub. No.: US 2024/0121005 A1
(43) Pub. Date: Apr. 11, 2024

(54) COMMUNICATION METHODS, TRANSMITTERS / RECEIVERS, REPEATERS, COMMUNICATION SYSTEMS AND PROGRAMS

(71) Applicant: NIPPON TELEGRAPH AND TELEPHONE CORPORATION, Tokyo (JP)

(72) Inventors: Satoshi NARIKAWA, Musashino-shi, Tokyo (JP); Toshihito FUJIWARA, Musashino-shi, Tokyo (JP); Hiroya ONO, Musashino-shi, Tokyo (JP)

(73) Assignee: NIPPON TELEGRAPH AND TELEPHONE CORPORATION, Tokyo (JP)

(21) Appl. No.: 18/276,249

(22) PCT Filed: Feb. 26, 2021
(86) PCT No.: PCT/JP2021/007515

§ 371 Date: Aug. 7, 2023

(51) Int. Cl. H04B 10/29; H04B 10/40

(52) U.S. Cl. CPC H04B 10/29; H04B 10/40

(57) ABSTRACT

An object of the present invention is to provide a communication method, a transceiver, a relay, a communication system, and a program capable of performing high-speed communication even in a case where there is an obstacle between two separated points in water.

In this communication method, two points each confirm the other's position by using sound wave communication which is likely to be diffracted as a wave due to a relatively small frequency and a large wavelength. Since the communication method uses optical wireless communication in which straightness is high but high-speed communication is possible, a path for communication while avoiding an obstacle via a relay is calculated. In the communication method, the relay is guided and moved to an appropriate place according to the calculated path, and a signal is transmitted and received by using optical wireless communication using the relay that has moved to an appropriate place.

### TECHNICAL FIELD

The present disclosure relates to an underwater communication method.

### BACKGROUND ART

As a method of performing wireless communication between two spatially separated points, there is a wireless communication method using radio waves. On the other hand, it is known that it is difficult to perform wireless communication using radio waves between two separated points in water due to large absorption and attenuation of radio waves in water (for example, refer to Non Patent Literature 1).

Therefore, in order to perform wireless communication between two separated points in water, there are a wireless communication method using sound waves and a wireless communication method using visible light (for example, refer to Non Patent Literature 2 and 3). Since sound waves and visible light have smaller attenuation in water than radio waves, wireless communication can be performed between two points separated farther away compared to the case of radio waves.

### CITATION LIST

### Non Patent Literature

Non Patent Literature 1: Xianhui Che; Ian Wells; Gordon Dickers; Paul Kear; Xiaochun Gong, “Re-evaluation of RF electromagnetic communication in underwater sensor networks”, IEEE Communications Magazine (Volume: 48, Issue: 12, P. 143-151, December 2010)
Non Patent Literature 2: Milica Stojanovic; James Preisig, “Underwater acoustic communication channels: Propagation models and statistical characterization”, IEEE Communications Magazine (Volume: 47, Issue: 1, P. 84-89, January 2009)
Non Patent Literature 3: Knowledge Base “Forest of Knowledge”, The Institute of Electronics, Information and Communication Engineers, 4th Group, Mobile and Wireless, 4th Edition, Wireless LAN, Wireless Access, Near-field Wireless, Chapter Y Optical Wireless Communication, P. 1-12

### SUMMARY OF INVENTION

### Technical Problem

Because sound waves have smaller attenuation in water than radio waves, a communication range can be expanded to farther places. However, there is a problem that it is difficult to increase a communication speed because a carrier frequency of sound waves is small (for example, refer to Non Patent Literature 2). On the other hand, while visible light allows a communication range to be expanded to farther places because it has smaller attenuation in water than radio waves, since visible light has high straightness, there is a problem that light is blocked in a case where there is an obstacle between two points, and it is difficult to perform communication (for example, refer to Non Patent Literature 3).

Therefore, in order to solve the problems of the two communication methods, an object of the present invention is to provide a communication method, a transceiver, a relay, a communication system, and a program capable of performing high-speed communication even in a case where there is an obstacle between two separated points in water.

### Solution to Problem

In order to achieve the above object, in a communication method according to the present invention, two points each confirm the other's position by using sound wave communication, a path through which communication can be performed while avoiding an obstacle via a relay is calculated such that optical wireless communication through which high-speed communication is possible can be performed, and the relay is guided and moved to an appropriate place according to the calculated path.

Specifically, a communication method according to the present invention includes:
recognizing positions of two transceivers by sound wave communication; calculating a relay position of the relay that enables optical wireless communication between the two transceivers via at least one relay; and
moving the relay to the calculated relay position.

Further, a transceiver according to the present invention includes:
an optical wireless communication unit configured to perform optical wireless communication with another transceiver;
a sound wave communication unit configured to recognize a position of the another transceiver by sound wave communication;
a calculation unit configured to calculate a relay position of a relay that enables optical wireless communication via at least one relay; and
a movement instruction unit configured to move the relay to the calculated relay position.

Furthermore, a relay according to the present invention includes:
a reception unit configured to receive, as an instruction, a position of the relay at which optical wireless communication is performed between two transceivers via the relay;
a moving unit configured to move the relay to the position of the relay included in the instruction; and
a relay unit configured to relay optical wireless communication between the two transceivers.

In addition, a communication system according to the present invention includes:
two transceivers configured to perform the optical wireless communication and the sound wave communication with each other; and
at least one relay configured to relay the optical wireless communication.

The two transceivers can each confirm the other's position by using sound wave communication in which the communication speed is low, but attenuation in water is small, it is possible to reach far places, and an obstacle can be avoided by diffraction. Then, the two transceivers are set as a start point and an end point, a path of a polygonal line that can avoid an obstacle is calculated, and the relay is moved to a vertex of the polygonal line. By using the path, high-speed communication can be performed by optical wireless communication having strong straightness.

Therefore, the present invention provides a communication method, a transceiver, a relay, and a communication system capable of performing high-speed communication even in a case where there is an obstacle between two separated points in water.

In the communication method according to the present invention, a current position of the relay is found before moving the relay. By finding the current position of the relay, the movement instruction becomes easy.

The communication method according to the present invention further includes finding an obstacle position of an obstacle region which is an obstacle to the optical wireless communication and positioning the relay position at a position where the optical wireless communication is performed while avoiding the obstacle region. It is also possible to respond to an exact position of an obstacle and a moving obstacle.

The present invention provides a program for causing a computer to function as the transceiver and the relay. A data collection device of the present invention can also be realized by a computer and a program, and the program can be recorded in a recording medium or provided through a network.

Note that each of the above inventions can be combined where possible.

### Advantageous Effects of Invention

The present invention can provide a communication method, a transceiver, a relay, a communication system, and a program capable of performing high-speed communication even in a case where there is an obstacle between two separated points in water.

### BRIEF DESCRIPTION OF DRAWINGS

FIG. 1 is a diagram illustrating a communication system according to the present invention.

FIG. 2 is a diagram for explaining a transceiver according to the present invention.

FIG. 3 is a diagram for explaining a relay according to the present invention.

FIG. 4 is a diagram for explaining an operation of the communication system according to the present invention.

FIG. 5 is a diagram illustrating the communication system according to the present invention.

FIG. 6 is a diagram illustrating the communication system according to the present invention.

FIG. 7 is a diagram for explaining the transceiver or the relay according to the present invention.

### DESCRIPTION OF EMBODIMENTS

Embodiments of the present invention will be described with reference to the accompanying drawings. The embodiments described below are examples of the present invention, and the present invention is not limited to the following embodiments. Note that components having the same reference numerals in the present specification and the drawings indicate the same components.

(Prerequisite Configuration)
(1) A transceiver is installed at a fixed position.

For example, the transceiver is an underwater sensor or the like, and is a device that is installed in a specific place and collects data without moving (without being able to move).

(2) A relay assists with communication between the transceivers.

The relay supports communication because direct communication cannot be performed between the transceivers.
(3) The relay has a moving function.

The (one or plurality of) movable relays are installed between the transceivers, and the relay is moved to perform high-speed communication via the relay.

### Embodiment 1

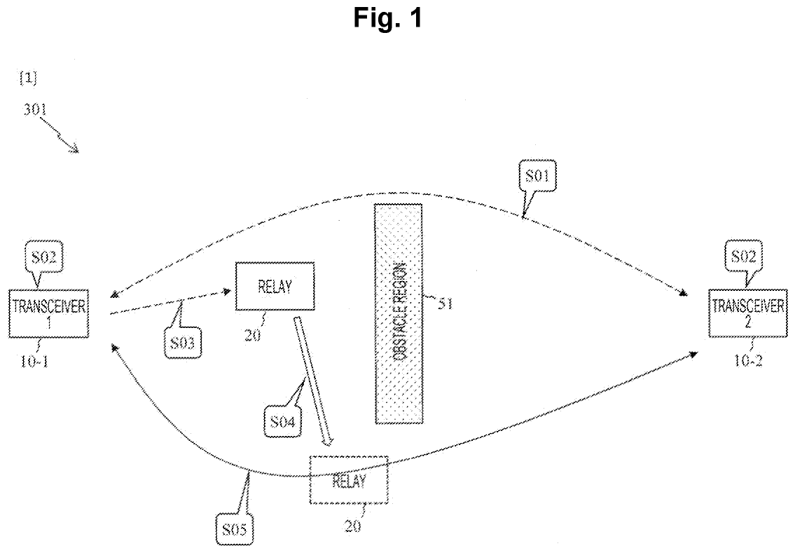

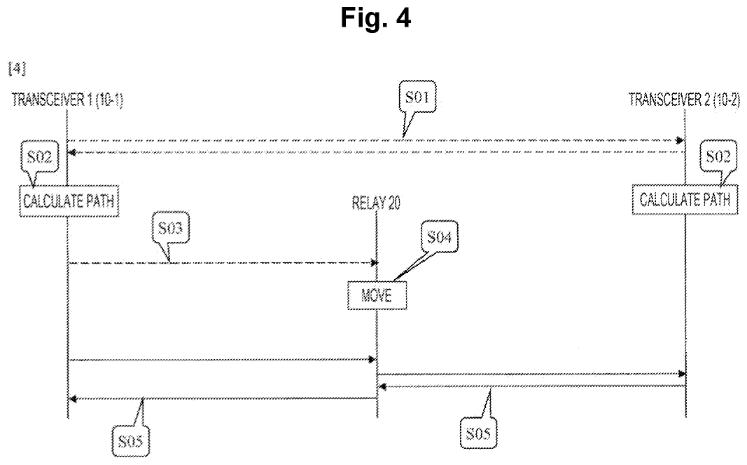

FIG. 1 is a diagram illustrating a communication system 301 of the present embodiment. The communication system 301 includes two transceivers (10-1, 10-2) that perform optical wireless communication and sound wave communication with each other, and at least one relay 20 that relays optical wireless communication. The communication system 301 performs the procedure described in FIG. 4 to initiate optical wireless communication between the two transceivers (10-1, 10-2) positioned underwater and at positions obstructed by an obstacle region 51.

The transceivers (10-1, 10-2) each confirm the other's position by sound wave communication that has a relatively small frequency and a long wavelength and is easily diffracted as a wave (step S01).

The transceivers (10-1, 10-2) find their own positions by the following means.
(1) Position information is registered in each transceiver at the time of initial installation.
(2) The position information of the transceiver is found by a global navigation satellite system (GPS or the like).
(3) It is found by three-point positioning using waves such as sound waves.
(4) Each of the transceiver and the relay finds relative position information.
(5) One of the devices finds the absolute position information, and finds the entire position from a relative positional relationship with the other devices.

The transceiver notifies the other transceiver of its own position found by such a method by sound wave communication.

At this time, in addition to finding the position information of the transceiver (10-1, 10-2), the position information of the relay 20, the shape of the terrain, and the shape and position information of the obstacle region 51 may be found.

As means for finding the position of the relay 20, the same technology as the method for finding the position information of the transceiver can be utilized.

In addition, the obstacle region 51 is, for example, a topographical obstacle such as a rock, or an artificial obstacle such as an underwater building. The shape and position information of the obstacle region 51 are obtained from the map information in the case of a topographical obstacle or an artificial obstacle.

However, the obstacle region 51 is not limited to a topographical obstacle or an artificial obstacle. The following region is also the obstacle region 51.
(1) A region in which the water is turbid, the current is severe, or the sea temperature is extremely high or extremely low. This region can be obtained from weather information.
(2) A region in which interference occurs in direct optical wireless communication in a section where a system of another person is shared. This region can be set in the system in advance.
(3) A region where the sea surface is extremely close and direct optical wireless communication is difficult due to the influence of reflection. This region can be estimated from position information (height information) of the transceiver or the relay.

Since the optical wireless communication in which straightness is high but high-speed communication is possible is used, a path for communication while avoiding the obstacle region 51 via the relay 20 is calculated (step S02).

As a method for calculating the path, a method for connecting the two transceivers (10-1, 10-2) by a straight line, assuming at least one point on the straight line, and moving the point to detour around the obstacle region 51 (referred to as a polygonal line) can be exemplified.

Note that it is not necessary to pass through all the relays 20, and it is not necessary to pass through the relay 20 as long as the start point and the end point can be connected by a straight line without hitting the obstacle region 51. Furthermore, the path may not be optimal (shortest) as long as optical wireless communication can be performed. In addition, in a case where bidirectional optical wireless communication is performed, the path may be different between the outward path and the return path.

The relay 20 is instructed to move to a position (a position of a vertex of the straight line) corresponding to the calculated path (step S03). The instruction can be performed by sound wave communication.

The relay 20 that has received the instruction moves to the instructed position (the position of the vertex of the straight line) (step S04).

The transceiver (10-1, 10-2) performs optical wireless communication using the relay 20 that has moved to an appropriate place as a relay point (step S05).

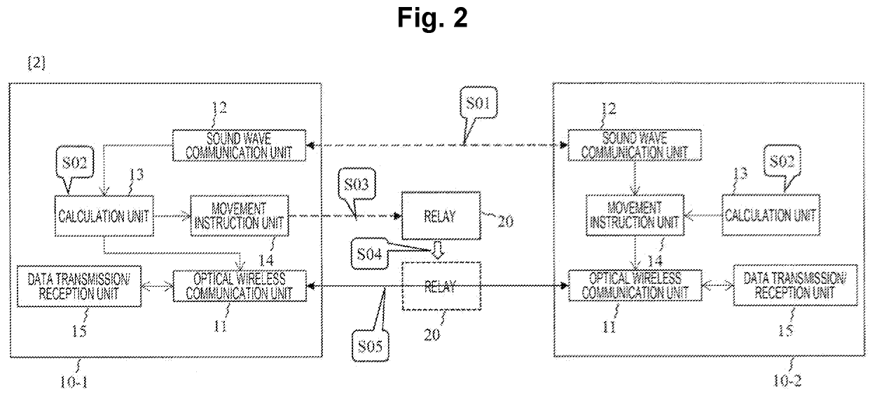

FIG. 2 is a functional block diagram for explaining a transceiver (10-1, 10-2). A transceiver (10-1, 10-2) includes:
an optical wireless communication unit 11 configured to perform optical wireless communication with another transceiver;
a sound wave communication unit 12 configured to recognize a position of the another transceiver by sound wave communication;
a calculation unit 13 configured to calculate a relay position of the relay 20 that enables optical wireless communication via at least one relay 20;
a movement instruction unit 14 configured to move the relay to the calculated relay position; and
a data transmission/reception unit 15 configured to process data transmitted and received by the optical wireless communication unit 11.

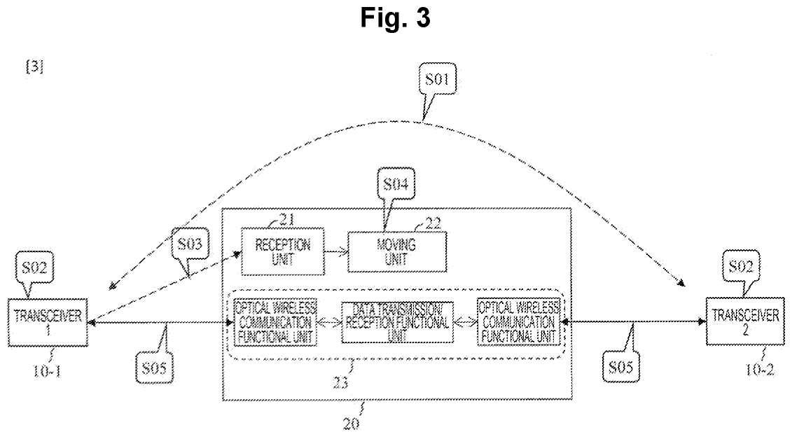

FIG. 3 is a functional block for explaining the relay 20. The relay 20 includes:
a reception unit 21 configured to receive, as an instruction, a position of the relay at which optical wireless communication is performed between two transceivers via the relay;
a moving unit 22 configured to move the relay to the position of the relay included in the instruction; and
a relay unit 23 configured to relay optical wireless communication between the two transceivers.

That is, each functional unit performs the following operation.

In step S01, the sound wave communication units 12 of the transceivers (10-1, 10-2) transmit and receive sound wave communication having a relatively low frequency, a long wavelength, and easily diffracted as a wave, and each confirm the other's position.

In step S02, the calculation unit 13 of the transceiver (10-1, 10-2) calculates a path for communication while avoiding the obstacle region 51 via the relay 20 for optical wireless communication in which straightness is high but high-speed communication is possible.

In step S03, the movement instruction unit 14 of the transceiver (10-1, 10-2) is instructed to move the relay 20 to a position (a position of a vertex of the straight line) corresponding to the calculated path. Then, the reception unit 21 of the relay 20 receives the instruction.

In step S04, the relay 20 moves to a position (a position of a vertex of the straight line) instructed by the moving unit 22.

In step S05, the relay unit 23 of the relay 20 that has moved relays the optical wireless communication of the optical wireless communication unit 11 of the transceiver (10-1, 10-2). As a result, the data transmission/reception unit 15 of the transceiver (10-1, 10-2) can transmit and receive data between the transceivers by optical wireless communication even when there is the obstacle region 51.

### Embodiment 2

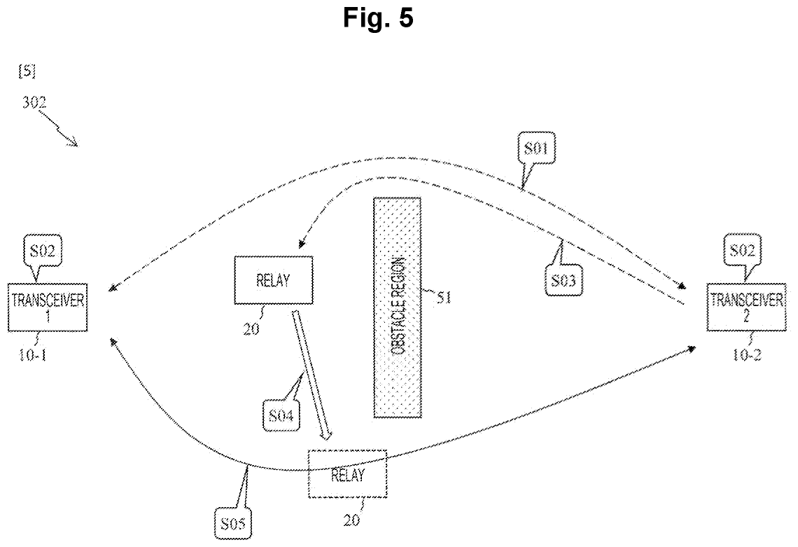

FIG. 5 is a diagram for explaining a communication system 302 of the present embodiment. The configuration in which the communication system 301 of Embodiment 1 outputs the movement instruction from the transceiver 10-1 to the relay 20 has been described. However, the movement instruction may be output from any of the transceivers. The communication system 302 is configured to output a movement instruction from the transceiver 10-2 to the relay 20. Configurations of the transceiver (10-1, 10-2) and the relay 20 of the communication system 302 are the same as those described in Embodiment 1.

### Embodiment 3

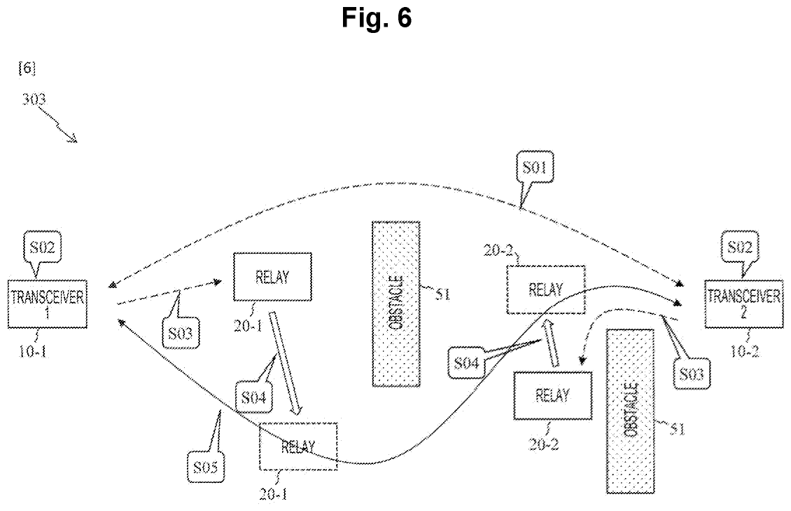

FIG. 6 is a diagram for explaining a communication system 303 of the present embodiment. The example in which the communication system 301 of Embodiment 1 and the communication system 302 of Embodiment 2 include only one relay 20 has been described. However, there may be a plurality of relays 20. The communication system 303 includes the plurality of relays 20 and is configured to move respective positions. In FIG. 6, it is described that the transceiver 10-1 gives a movement instruction to the relay 20-1 and the transceiver 10-2 gives a movement instruction to the relay 20-2, but the movement instruction to each relay may be output from any transceiver. Configurations of the transceiver (10-1, 10-2) and the relay 20 of the communication system 303 are the same as those described in Embodiment 1.

### Embodiment 4

The transceiver 10 and the relay 20 described above can also be realized by a computer and a program, and the program can be recorded in a recording medium or provided through a network.

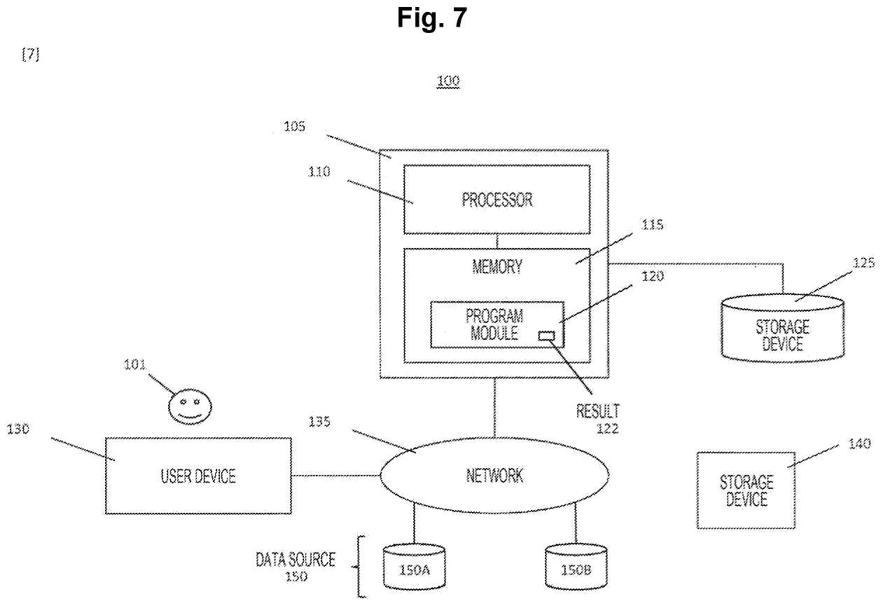

FIG. 7 illustrates a block diagram of a system 100. The system 100 includes a computer 105 connected to a network 135.

The network 135 is a data communication network. The network 135 may be a private network or a public network, and may include any or all of (a) a personal area network, for example, covering a room, (b) a local area network, for example, covering a building, (c) a campus area network, for example, covering a campus, (d) a metropolitan area network, for example, covering a city, (e) a wide area network, for example, covering a region connected across boundaries of cities, rural areas, or countries, and (f) the Internet. Communication is performed by an electronic signal and an optical signal via the network 135.

The computer 105 includes a processor 110 and a memory 115 connected to the processor 110. The computer 105 is represented herein as a standalone device, but is not limited thereto, and may be connected to other devices (not illustrated) in a distributed processing system.

The processor 110 is an electronic device including logic circuitry that responds to and executes instructions.

The memory 115 is a tangible computer readable storage medium in which a computer program is encoded. In this regard, the memory 115 stores data and instructions, that is, program codes, that are readable and executable by the processor 110 to control the operation of the processor 110. The memory 115 can be realized by a random access memory (RAM), a hard drive, a read-only memory (ROM), or a combination thereof. One of the components of the memory 115 is a program module 120.

The program module 120 includes instructions for controlling the processor 110 to execute processes described in the present specification. In the present specification, it is described that operations are executed by the computer 105, a method, a process, or a sub-process thereof. However, the operations are actually executed by the processor 110.

The term “module” is used herein to refer to a functional operation that may be embodied either as a stand-alone component or as an integrated configuration of a plurality of sub-components. Therefore, the program module 120 can be realized as a single module or as a plurality of modules that operate in cooperation with each other. Furthermore, although the program module 120 is described in the present specification as being installed in the memory 115 and thus realized in software, the program module 120 can be realized in any of hardware (for example, an electronic circuit), firmware, software, or a combination thereof.

Although the program module 120 is shown as already loaded into the memory 115, the program module 120 may be configured to be positioned on a storage device 140 to be subsequently loaded into the memory 115. The storage device 140 is a tangible computer readable storage medium that stores the program module 120. Examples of the storage device 140 include a compact disk, a magnetic tape, a read-only memory, an optical storage medium, a hard drive or a memory unit including a plurality of parallel hard drives, and a universal serial bus (USB) flash drive. Alternatively, the storage device 140 may be a random access memory or another type of electronic storage device positioned in a remote storage system (not illustrated) and connected to the computer 105 via the network 135.

The system 100 further includes a data source 150A and a data source 150B collectively referred to herein as a data source 150, and communicatively connected to the network 135. In practice, the data source 150 may include any number of data sources, that is, one or more data sources. The data source 150 may include unstructured data and may include social media.

The system 100 further includes a user device 130 operated by a user 101 and connected to the computer 105 via the network 135. The user device 130 includes an input device, such as a keyboard or a voice recognition subsystem, for enabling the user 101 to communicate information and command selections to the processor 110. The user device 130 further includes an output device such as a display device, a printer, or a voice synthesizer. A cursor control unit such as a mouse, a trackball, or a touch-sensitive screen allows the user 101 to manipulate a cursor on the display device to communicate further information and command selections to the processor 110.

The processor 110 outputs a result 122 of execution of the program module 120 to the user device 130. Alternatively, the processor 110 can provide the output to a storage device 125 such as a database or memory or to a remote device (not illustrated) via the network 135.

For example, a program for causing a computer to realize each function described in FIG. 2 may be used as the program module 120. The system 100 can be operated as the transceiver 10. In addition, a program for causing a computer to realize each function described in FIG. 3 may be used as the program module 120. The system 100 can be operated as the relay 20.

The term “comprise . . . ” or “comprising . . . ” specifies that the mentioned features, integers, steps, or components are present, but should be construed as not excluding the presence of one or more other features, integers, steps, or components, or groups thereof. The terms “a” and “an” are indefinite articles for an object and therefore do not exclude embodiments having a plurality of objects.

### OTHER EMBODIMENTS

Note that the present invention is not limited to the above embodiments, and various modifications can be made without departing from the gist of the present invention. In short, the present invention is not limited to the high-order embodiments as they are, and can be embodied by modifying the components without departing from the gist of the present invention at the implementation stage.

In addition, various inventions can be made by appropriately combining a plurality of components disclosed in the above embodiments. For example, some components may be deleted from all the components shown in the embodiments. Furthermore, components in different embodiments may be appropriately combined.

### REFERENCE SIGNS LIST

10, 10-1, 10-2 Transceiver
11 Optical wireless communication unit
12 Sound wave communication unit
13 Calculation unit
14 Movement instruction unit
15 Data transmission/reception unit
20, 20-1, 20-2 Relay
21 Reception unit
22 Moving unit
23 Relay unit
100 System
101 User
105 Computer
110 Processor
115 Memory
120 Program module
122 Result
125 Storage device
130 User device
135 Network
140 Storage device
150 Data source
301 to 303 Communication system

1. A communication method comprising:
recognizing positions of two transceivers by sound wave communication;
calculating a relay position of the relay that enables optical wireless communication between the two transceivers via at least one relay; and
moving the relay to the calculated relay position.

2. The communication method according to claim 1, wherein a current position of the relay is found before moving the relay.

3. The communication method according to claim 1, comprising:
finding an obstacle position of an obstacle region which is an obstacle to the optical wireless communication; and
positioning the relay position at a position where the optical wireless communication is performed while avoiding the obstacle region.

4. A transceiver comprising:
an optical wireless communication unit configured to perform optical wireless communication with another transceiver;
a sound wave communication unit configured to recognize a position of the another transceiver by sound wave communication;
a calculation unit configured to calculate a relay position of a relay that enables optical wireless communication via at least one relay; and
a movement instruction unit configured to move the relay to the calculated relay position.

5. A relay comprising:
a reception unit configured to receive, as an instruction, a position of the relay at which optical wireless communication is performed between two transceivers via the relay;
a moving unit configured to move the relay to the position of the relay included in the instruction; and
a relay unit configured to relay optical wireless communication between the two transceivers.

6. (canceled)

7. A program for causing a computer to function as the transceiver according to claim 4.

8. A program for causing a computer to function as the relay according to claim 5.
